(19) United States
(12) Patent Application Publication
(10) Pub. No.: US 2011/0259563 A1
(43) Pub. Date: Oct. 27, 2011

(54) CONNECTION ELEMENT FOR TUBULAR HEAT EXCHANGER

(75) Inventors: Johann Justl, Regensburg (DE); Michael Porringer, Pentling (DE)

(73) Assignee: KRONES AG, Neutraubling (DE)

(21) Appl. No.: 13/091,222

(22) Filed: Apr. 21, 2011

(30) Foreign Application Priority Data
Apr. 22, 2010 (DE) 102010028117.4

(51) Int. Cl. F28F 1/00; B23P 15/26

(52) U.S. Cl. 165/178; 29/890.053

(57) ABSTRACT

Connection element for connecting a heat exchanger element of a tubular heat exchanger with at least one product-carrying pipe to a flow system, where the connection element has a through hole, and a flow separation edge is formed on the circumference of the through hole.

### CROSS-REFERENCE TO RELATED APPLICATION

The present application claims the benefit of priority of German Application No. 102010028117.4, filed Apr. 22, 2010. The entire text of the priority application is incorporated herein by reference in its entirety.

### FIELD OF THE DISCLOSURE

The disclosure relates to a connection element for connecting a heat exchanger element of a tubular heat exchanger with at least one product-carrying tube to a flow system.

### BACKGROUND

When tubular heat exchangers with one or more heat exchanger elements are used for fibrous products, it happens that the fibers block up the feed of a heat exchanger element in the area of the interior tubes that form the tube bundle, whereby these interior tubes form the flow channels for a product. In order to prevent this, it has already been proposed in the state of the art to arrange turbulence creators in the inflow channel in the middle of the inlet area in order to avoid deposits with the help of the turbulence created in this way.

For example, tubular heat exchangers are known from EP 1 604 162 B1 and DE 10 2005059 463 B4 in which a flow in the inlet area of a tube support plate is influenced by means of a displacer around which the product is to flow.

From DE 696 12 998 T2, tubular heat exchangers are known in which a deflection plate designed with flow distributors is arranged at the flowed-against ends of heat exchanger tubes whereby the surface of the flow distributors facing towards the product flow is convex.

Detrimental in these known displacers, however, is that the manufacture of these displacers is complicated, they frequently must have complicated shapes that are different for facing towards and facing away from the product flow and that in particular, undesired and disruptive shadowing effects can also occur.

### SUMMARY OF THE DISCLOSURE

An aspect of the disclosure is formed by fashioning a connection element for a tubular heat exchanger with at least one heat exchanger element and at least one product-carrying tube, in which fiber deposits in the inlet area of the heat exchanger element of the tubular heat exchanger can be reduced or avoided.

According to the disclosure, a modular component is pre-arranged as a connection element in the inlet area of the heat exchanger element, whereby this component forms a flow separation edge for turbulence, whereby this flow separation edge runs around the outer circumference and is preferably but not necessarily circular. This achieves a clear reduction or avoidance of fiber deposits so that a correspondingly equipped or retrofitted system achieves longer life spans, corresponding maintenance intervals can be longer, and, during maintenance, the system is easier to clean in the inlet area of the heat exchanger element of the tubular heat exchanger. The connection element is moreover correspondingly simple to manufacture and to equip on new tubular heat exchangers and simple to retrofit on existing tubular heat exchangers.

Due to the flow separation edge, a corresponding control of the flow rate and creation of turbulence are furthermore achieved, as a result of which fiber deposits are in turn reduced in the inlet area of the tubular heat exchanger. At the same time, the product flow typically flows out of the product-carrying tube into the inside of the heat exchanger element. This means that the product flow flows, with respect to the connection element, from upstream into the connection element and flows out of the connection element into the heat exchanger element of the tubular heat exchanger, whereby this heat exchanger element is, for example, located directly downstream of the connection element. The product-carrying tube out of which the product flows by way of the connection element and into the heat exchanger element can thereby be curved as in a connection bend or it can be a straight tube. The connection element typically has an axisymmetric cross-section. The longitudinal axis of the connection element furthermore preferably corresponds to the longitudinal axis of the heat exchanger element of the tubular heat exchanger. The heat exchanger element of the tubular heat exchanger thereby comprises, for example, a plurality of interior tubes for conducting the product, whereby the interior tubes are held by a tube support plate.

The connection element can thereby be mountable modularly between the heat exchanger element of the tubular heat exchanger and the at least one product-carrying tube. A modularly mountable connection element is simple to mount, or simple to retrofit in existing systems, and simple to maintain when necessary. Its manufacture is decoupled from the manufacture tubular heat exchanger and a remaining filling system connected to it, and is correspondingly simple to manufacture.

The flow separation edge on the circumference of the through hole of the connection element can advantageously be tapered or rounded. These shapes thereby favor the flow separation at the flow separation edge.

The flow separation edge can be formed at an angle a measured to the longitudinal axis of the connection element. whereby a measures a maximum of 90°. By means of the corresponding forming of the flow separation edge, the turbulence creation and the flow separation are further favored, whereby the flow separation edge points at an angle a in the flow direction.

The through hole of the connection element can, for example, be formed so that it is symmetric to the longitudinal axis of the connection element. With such a selection of the form, the connection element is especially simple to manufacture and thereby achieves the advantages with regard to the flow already mentioned above.

The through hole can thereby be given a circular shape, as a result of which advantages with regard to the manufacture result, in addition to the advantages with regard to the flow.

The through hole can have an inside diameter d, in the area of the flow separation edge, whereby typically the inside diameter of the through hole decreases from an inlet opening facing away from the heat exchanger element and having a first inside diameter d₁ to an inside diameter dᵢ in the area of the flow separation edge and subsequently typically increases from the inside diameter dᵢ to an outlet opening facing towards the heat exchanger element and having a second inside diameter d₂. The area of the flow separation edge is thereby located between the inlet opening and the outlet opening, whereby typically dᵢ is less than d₁ and less than d₂. It can thereby be demonstrative to consider the surface of the inlet opening as a first surface with a first inside diameter d₁, and the surface of the outlet opening as a second surface with a second inside diameter d₂. In the area of the flow separation edge, the surface of the through hole, which is located between the first and the second surface, can have an inside diameter dᵢ, whereby d is less than d₁ and less than d₂. Due to the different inside diameters, a corresponding control of the flow rate is achieved and the turbulence creation is favored particularly in the area of the flow separation edge, which means the surface with the inside diameter dᵢ, as a result of which fiber deposits are in turn reduced in the inlet area of the tubular heat exchanger.

In an expedient formation, the connection element can be formed symmetrically to the through hole, as a result of which there result advantages with regard to the manufacture, in addition to advantages with regard to the flow. It can thereby be demonstrative to consider the connection element as formed so that it is symmetric to the surface that is located between the first surface with the first inside diameter d₁ and the surface with the second inside diameter d₂. With such a selection of the shape, the connection element is especially simple to manufacture and nevertheless achieves the advantages with regard to the flow already mentioned above.

In a further formation, the second inside diameter d₂ can be greater than the first inside diameter d₁. In this way, in particular the product can be distributed across a greater cross-section on the side of the heat exchanger element of the tubular heat exchanger and the product flow can be correspondingly better controlled.

The inside diameter of the through hole can, for example, change continuously from the inlet opening with the first inside diameter d₁ to the inside diameter dᵢ and then continuously change from the inside diameter dᵢ to the outlet opening with the second inside diameter d₂. It can thereby be demonstrative to consider a cross-section of the connection element according to the disclosure as described above which, for example, changes continuously from the first inside diameter d₁ of the first surface to the inside diameter dᵢ and furthermore changes continuously from the inside diameter d, to the second inside diameter d₂ of the second surface. The first surface and the second surface typically have the same orientation. The steady, gentle change of the inside diameter of the connection element furthermore favors the flow control, particularly in the area in front of the flow separation edge and in the area behind the flow separation edge.

In a further expedient formation, a connection element according to the disclosure can, in an area located between the inlet opening and the flow separation edge, comprise indentations (recesses), particularly part-circular indentations (recesses). The flow separation edge can be effectively lengthened in the mentioned area by means of such indentations (recesses), so that the turbulence creation can be correspondingly amplified, which has a positive effect on the reduction of fiber deposits downstream in the inlet area of the tubular heat exchanger.

The part-circular indentations (recesses) can thereby be arranged axisymmetrically to the longitudinal axis of the connection clement.

By wav of example, the inside diameter of the through hole can continuously decrease between the inlet opening with the inside diameter d₁ and the area of the flow separation edge with the inside diameter dᵢ outside of, particularly between, the respective part-circular indentations from the first inside diameter d₁ to the inside diameter dᵢ. In this way, the inside diameter can behave in a manner similar to that in the previously described embodiment between the part-circular indentations (recesses), meaning in the area that is not recessed. Due to the steady change from the inside diameter d₁ to the inside diameter dᵢ, it is possible in particular to concentrate the turbulence creation in the area of the flow separation edge. The steady, gentle change of the inside diameter of the connection element can thereby favor the flow control.

The disclosure furthermore provides a tubular heat exchanger with at least one heat exchanger element with a jacketed tube and at least one interior tube and with a connection element according to the disclosure, as described above. The advantage of such a tubular heat exchanger is the corresponding control and reduction of fiber deposits in the influx area in a heat exchanger element, which has a connection element according to the disclosure pre-arranged before it.

The disclosure furthermore provides a method for retrofitting a flow system with a tubular heat exchanger with at least one heat exchanger element and at least one product-carrying tube, comprising connecting of an end of the heat exchanger element with a connection element to a side of the connection element facing towards the heat exchanger element, and connecting of the connection element to the product-carrying tube on the side turned away from the heat exchanger element. By means of such a retrofitting method, the effectivity, maintenance and operating times of a tubular heat exchanger can be advantageously influenced.

### BRIEF DESCRIPTION OF THE DRAWINGS

Embodiments of the subject matter of the disclosure are explained using the drawings. Shown are:

FIG. 1 a schematic longitudinal section of a module of an exemplary tubular heat exchanger with it least one heat exchanger element with a connection element corresponding to the disclosure.

FIG. 1a a tube support plate in the feed area of a heat exchanger element of a tubular heat exchanger as shown in FIG. 1.

FIG. 1b a use of a connection element according to the disclosure in the connection of a plurality of heat exchanger elements.

FIG. 2 a schematic representation of a first embodiment corresponding to the present disclosure.

FIG. 2a a sectional view of he embodiment from FIG. 2 along the cutting line that is drawn in.

FIG. 3 a schematic representation of a further embodiment corresponding to the present disclosure.

FIG. 3a a sectional view of the embodiment from FIG. 3 along the cutting line that s drawn in.

FIG. 4 a schematic representation of a further embodiment corresponding to the present disclosure, as a variation of the embodiment from FIG. 3.

FIG. 4a a sectional view of the embodiment from FIG. 4 corresponding to the cutting line that is drawn in.

### DETAILED DESCRIPTION OF THE PREFERRED EMBODIMENT

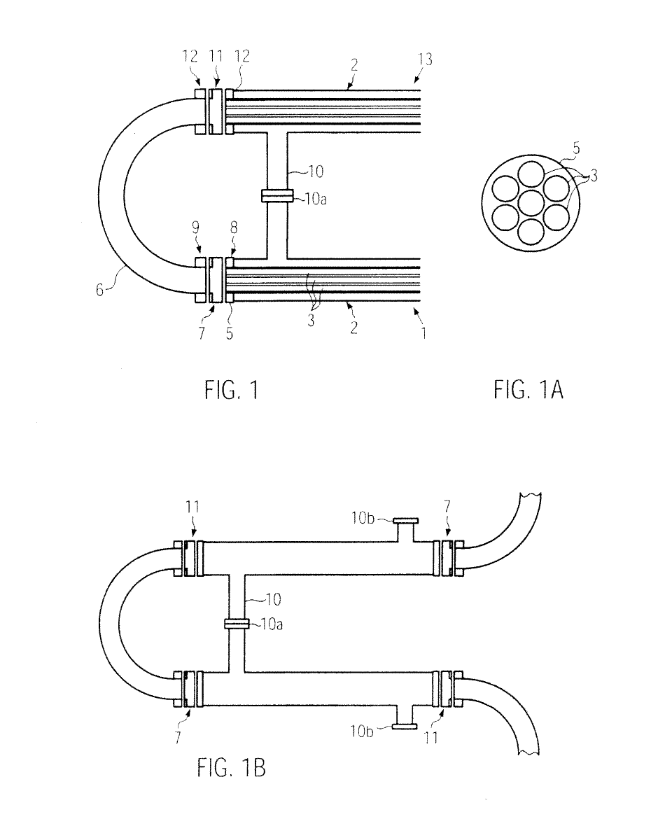

FIG. 1 illustrates a tubular heat exchanger with at least one heat exchanger element 1 and a further product-carrying tube 13 that are connected to a further product-carrying tube that is curved, namely a connection bend 6. The tubular heat exchanger with the at least one heat exchanger element 1, the product-carrying tube 13 and the connection bend 6 are of the type such as is used, for example, in the bottling and filling industry for liquid food products (e.g., water, juices, milk) during the heat treatment (heating or cooling) of a food product. A plurality of modules, namely heat exchanger elements 1, can be built into the tubular heat exchanger in order to achieve the longest possible flow paths for the product. The connection of the further product-carrying tube 13 to the connection bend 6 is executed in FIG. 1 by corresponding mourning flanges 12 at the ends. A connection element 11 is deployed for connection between the flanges 12 in FIG. 1. The connection element 11 can thereby be, for example, a further element according to the disclosure of the type such as the connection clement 7 according to the disclosure, or it can be a simple adapter or spacer piece.

The heat exchanger element 1 of the tubular heat exchanger in FIG. 1 has a jacketed tube 2, advantageously, e.g., of stainless steel (however also of other alloys or, for example, also of titanium, zinc or special plastics), that has on each end mounting flanges 8, here shown only on the left side, for mounting of the heat exchanger element 1 in a system such as shown in FIG. 1. One or more interior tubes 3 are provided in the jacketed tube 1, whereby these interior tubes extend essentially paraxially to the jacketed tube 1 between mounting flanges 8. A plurality of interior tubes 3 are typically combined into a tube bundle in the embodiment in FIG. 1. A primary flow circulates in the interior tubes 3, whereby this primary flow is a liquid food product that can contain additional fibers such as fruit pulp or fibrous pieces. A secondary flow typically circulates in the jacketed tube 1, so that a temperature exchange (cooling or heating) can occur with the primary flow, which flows in the interior tubes 3.

The bundle of one or more interior tubes 3 in the feed area of the heat exchanger element is held by a tube support plate 5, whereby the tube support plate 5 is essentially mounted perpendicularly to the longitudinal axis of the heat exchanger element 1. FIG. 1A shows a schematic top view of a tube support plate 5 that combines seven interior tubes in this example.

The tube 13 shown in FIG. 1 can be a further heat exchanger element of the same type as the heat exchanger element 1. The direction of flow of the primary flow is, for example, from the tube 13 into the connection bend 6 and from there into the heat exchanger element 1, which is connected to the connection bend 6 with the help of the connection element 7 according to the disclosure. The connection element 11 at the flow end of the tube 13 can thereby be a further connection element according to the disclosure of the same type as the connection element 7. It is furthermore likewise possible that the connection element 11 has only an adapter function and does not have any gate-like narrowing as described below. FIG. 1B shows an example of the connection of a plurality of heat exchanger elements in a tubular heat exchanger system, whereby each of the connection bends 6 deflects the primary flows by 180° in this example. The connection elements 7 and 11 can thereby, as shown in FIGS. 1 and 1B, be mounted in the inflow and outflow area of tubes 1 and 13, respectively, but it would likewise he possible (not shown here) for the connection elements 7 according to the disclosure to be mounted both in the inflow and in the outflow areas of elements 1 and 13.

In FIG. 1 and FIG. 1B, the secondary flow, which consists of a suitable heat exchange medium, e.g., water, is not deflected via the connection bends 6 and is instead deflected directly to the next heat exchanger element with the help of a connection tube 10 and a connection piece with flanges 10a, which can also contain a valve. As a rule, the secondary medium is conducted in a flow that flows counter to the primary medium. The connection bend 6 consequently deflects only the primary flow in this case. FIG. 1 shows by way of example how a connection tube 10 connects directly to the jacketed tube 2. It is likewise possible, as shown in FIG. 1B, for the connection tube to be connected by means of connector terminals 10b on the sides in order to make it possible to pass on the secondary flow. It is furthermore possible (not shown) for a connection bend also to deflect the secondary flow, whereby the connection tubes 10 can be eliminated, and the secondary flow is suitably conducted past the connection elements according to the disclosure.

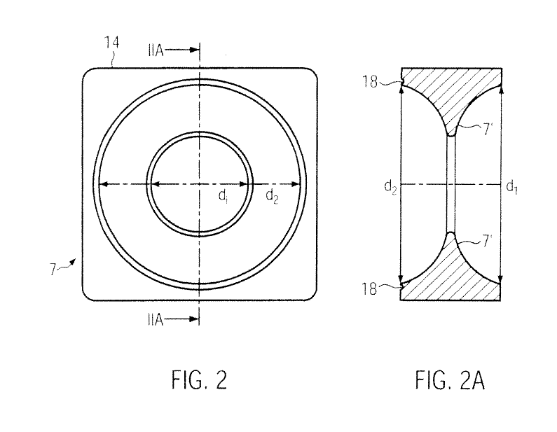

FIGS. 1, 1A and 1B show connection elements 7 and 11 executed as separate, modular elements. It is, however, likewise possible to integrate a connection element according to the disclosure of the same type as elements 7, 17 and 27, which are described with regard to FIGS. 2-4, into the connection bend 6 or into the tube bundle in its inflow area, for example, in combination with the tube support plate 5. Tubular heat exchangers such as shown in FIGS. 1 and 1B can have a total length of approximately 3.0 m, 6.0 m or even longer.

FIG. 2 and FIG. 2A show an exemplary embodiment of a connection element 7 according to the disclosure for coupling the connection bend 6 to the heat exchanger element 1 of the tubular heat exchanger. FIG. 2 shows a cut through the connection element 7 at a right angle to its longitudinal axis, and consequently typically at aright angle to the longitudinal axis of the heat exchanger element 1. The product flows, for example, through the connection bend 6 into the heat exchanger element 1 with its interior tubes 3, by means of which the flow direction is given. The connection element 7 is inserted modularly in the coupling area between the output flange 9 of the connection bend 6 and the input flange 8 of the heat exchanger element 1 in that it is suitably mounted with the respective flanges 9 and 8. The connection element 7 can have a suitable mounting bracket 14 for mounting between the flanges 8 and 9, furthermore a flow separation edge (narrowing) 7′ that can have a gate-like effect and that lies, for example, axisymmetrically to the longitudinal axis of the flanges 8 and 9, as well as of the heat exchanger element 1. FIG. 2A shows a corresponding sectional drawing along, the line IIA though the connection element 7. The flow separation edge 7′ is formed on the circumference of the through hole of the connection element 7. The flow separation edge 7′ runs around the through hole. The flow separation edge can be formed so that it is axisymmetric and circular and, as shown in FIG. 2, it can have an inside diameter of d The connection element furthermore has an inlet opening that faces away from the heat exchanger element 1 of the tubular heat exchanger, as well as an outlet opening that faces towards the heat exchanger element 1. In this way, there then results on the side of the inlet opening a first surface of the opening that faces away from the tubular heat exchanger and that has a first inside diameter d₁ and, on the side of the outlet opening, a second surface of the opening with an inside diameter d₂. Relative to the product flow, the first surface consequently lies upstream when viewed from the connection element while the second surface lies downstream. The inside diameter d₁ on the side far from the heat exchanger element 1 of the tubular heat exchanger roughly corresponds to the inside diameter of the connection bend 6. The inside diameter d₂ roughly corresponds to the inside diameter of the jacketed tube of the heat exchanger element 1 of the tubular heat exchanger, whereby the inside diameter is relative to the longitudinal axis in each case. As indicated in FIG. 2A, the inside diameter of the through hole preferably symmetrically and continuously (smoothly) decreases until the inside diameter dᵢ is reached in the area of the flow separation edge. The shape that arises due to the decrease is roughly similar to a spherical surface segment (spherical cap). The flow separation edge 7′ at which the flow of the fluid flowing through the element should preferably separate is typically tapered or rounded. In the case of a tapering, this tapering is formed in the flow direction. The preferably rounded flow separation edge 7′ thereby points essentially perpendicularly to the longitudinal axis of the connection element. O-ring grooves 18 that can hold a suitable O-ring are drawn in on the side facing towards the heat exchanger element by way of example. These grooves are formed to be roughly circular in FIG. 2A, but other suitable shapes of the grooves are also conceivable. There can likewise also be O-ring grooves on the upstream side (not shown here).

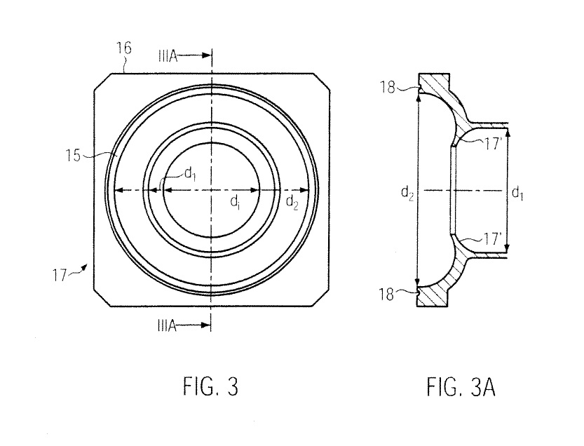

FIG. 3 shows a further formation of a connection element 17 that has further advantages with regard to the flow. FIG. 3 shows a cut through the connection element 17 at a right angle to the longitudinal axis. The design of the connection clement 17 in FIG. 3 is similar to that of the connection element 7 shown in FIG. 2. Similar to connection element 7, connection element 17 can be used for connecting connection bends and heat exchanger elements as shown in FIGS. 1, 1A and 1B. It has a mounting bracket 16, an O-ring groove 15 and a flow separation edge (narrowing) 17′, which runs around a surface (opening) that has an inside diameter dᵢ. There are furthermore an inlet opening with a surface with an inside diameter d₁ formed on the side far from the heat exchanger element 1 of the tubular heat exchanger and an outlet opening with a surface with an inside diameter d₂ formed on the side near the tubular heat exchanger. FIG. 3A shows a cut through the element from FIG. 3a along the cutting line IIIA that is drawn in. Similar to the manner indicated in FIG. 2A, the through hole decreases, preferably symmetrically to the longitudinal axis, continuously in a cup-like shape or similar to a spherical surface segment (spherical cap) from the inlet opening with the inside diameter d₁ to the flow separation edge 17′ with the inside diameter dᵢ. On the side near the heat exchanger element 1 of the tubular heat exchanger, the inside diameter of the through hole increases in until the inside diameter d₂ is reached in the area of the outlet opening. The inside diameter d₂ is advantageously coordinated to the size of the jacketed tube of the tube bundle and consequently is greater than the inside diameter d₁. Equivalent to FIG. 2A, O-ring grooves 18 are shown in FIG. 3A on the downstream side of the connection element.

The flow separation edge 17′ which can in turn be tapered or rounded and which runs around the circumference thereby points, however, at an angle a measured to the longitudinal axis as drawn in. The angle α can thereby take on values according to the circumstances, in the case shown by way of example, e.g., approximately 45-60°, whereby other values are also possible for this angle up to a maximum of 90°. In FIG. 3A, the inside diameter of the heat exchanger element 1 of the tubular heat exchanger that is to be connected to the connection bend by means of the connection element 17 is greater than the inside diameter of the connection bend. The shape and orientation of the flow separation edge (narrowing) 17′ correspondingly favor the flow separation and consequently the control and reduction of fiber deposits in the inlet area of the heat exchanger element of the tubular heat exchanger 1.

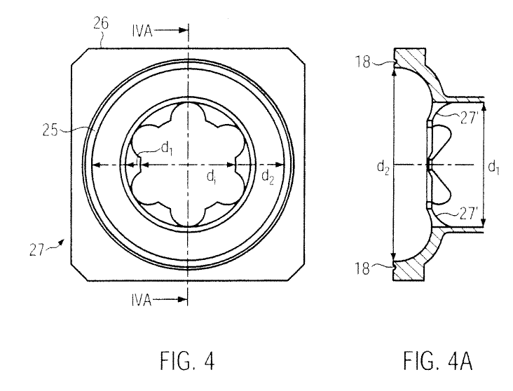

FIG. 4 show s a further formation of a connection element 27 that has further advantages with regard to the flow. Like connection element 7, connection clement 27 can be used for connecting connection bends and heat exchanger elements as shown in FIGS. 1, 1A and 1B. FIG. 4 shows a cut through the connection element 27 at a right angle to the longitudinal axis. FIG. 4A shows a cut through the element from FIG. 3a along the cutting line IVA that is drawn in. The connection element 27 in turn has a suitable mounting bracket 26. An O-ring groove 25 is shown as in FIG. 3. Based on the connection element from FIG. 3 and FIG. 3A, the area, as schematically indicated in FIG. 4, between an inlet opening with an inside diameter d₁ and the area of the flow separation edge 27′ is initially formed in a manner similar to that in FIG. 3 and FIG. 3A. Additionally formed in this area are a plurality of, for example, part-circular, preferably symmetrical indentations (recesses). FIG. 4 shows, for example, six part-circular indentations (recesses). The inside diameter of the through hole thereby decreases, as indicated in FIG. 4A, between the respective indentations (recesses), meaning in the area that is not recessed, along the longitudinal axis in the flow direction until the flow separation edge with the diameter dᵢ. This reduction of the inside diameter of the through hole is, as already described with regard to FIGS. 3 and 3A, cup-shaped or similar to a spherical surface segment. The flow separation edge 27′ points, as in FIG. 3A, in the flow direction and forms an angle a to the longitudinal axis of the connection element, whereby this angle can assume the values corresponding to the circumstances, for example, similar to the values mentioned in connection with FIGS. 3 and 3A. The flow separation edge 27′ can be tapered or rounded, as already discussed in connection with FIGS. 3 and 3A. As in FIGS. 2A and 3A, O-ring grooves 18 are drawn into FIG. 4A on the side of the connection element that is downstream.

In the embodiments shown, the width of the connection elements is somewhat less than 50 mm. Preferred inside diameters of the heat exchanger elements of the tubular heat exchangers can be 140 mm, but forms with larger inside diameters can also occur. Inside diameters of the connection bends amount, for example, to 80 mm, but other forms with larger inside diameters are also possible.

The connection elements according to the disclosure and shown in the figures can be modularly retrofitted into existing tubular heat exchangers, whereby in the framework of the method for retrofitting, the connection elements are inserted between a product-carrying tube and an end of a heat exchanger element of a tubular heat exchanger and are correspondingly connected to the product-carrying tube or other heat exchanger elements on the side facing away from the heat exchanger element, while they are connected to the heat exchanger element on the side facing towards the heat exchanger element. Applications in systems with a plurality of heat exchanger elements such as in FIG. 1B are thereby also conceivable, in which various connection elements 7, 17 and 27 according to the disclosure are used, in addition to adapter elements of the type like element 11.

1. Connection element for connecting a heat exchanger element of a tubular heat exchanger with at least one product-carrying pipe to a flow system, comprising a connection element having a through hole, and a flow separation edge formed on, a circumference of e through hole.

2. The connection element according to claim 1, wherein the connection element is modularly mountable between the heat exchanger element and the at least one product-carrying pipe.

3. The connection element according to claim 1, wherein the flow separation edge is one of tapered or rounded.

4. The connection element according claim 1, wherein the flow separation edge is formed at an angle α measured to the longitudinal axis of the connection element, wherein the angle α measures a maximum of 90°.

5. The connection element according to claim 1, wherein the through hole is formed symmetrically to the longitudinal axis of the connection element.

6. The connection element according to claim 1, wherein the through hole is formed so as to be circular.

7. The connection element according to claim 6, wherein the through hole has an inside diameter dᵢ in the area of the flow separation edge, wherein the inside diameter of the through hole decreases from an inlet opening facing away from the heat exchanger element from a first inside diameter d₁ to the inside diameter dᵢ in the area of the flow separation edge, and increases from the inside diameter dᵢ to an outlet opening facing towards the heat exchanger element with a second inside diameter d₂, wherein the area of the flow separation edge is located between the inlet opening and the outlet opening, and wherein dᵢ is less than d₁ and less than d₂.

8. The connection element according to claim 1, wherein the connection element is formed to be symmetric to the through hole.

9. The connection element according to claim 7, wherein the second inside diameter d₂ is greater than the first inside diameter d₁.

10. The connection element according to claim 6, and wherein an inside diameter of the through hole changes continuously from the inlet opening with the first inside diameter d₁ to the inside diameter dᵢ and changes continuously from the inside diameter dᵢ to the outlet opening with the second inside diameter d₂.

11. The connection element according to claim 6, wherein the connection element comprises indentations in an area located between the inlet opening and the flow separation edge.

12. The connection element according to claim 16, wherein the part-circular indentations are arranged axisymmetrically to the longitudinal axis of the connection element.

13. The connection element according to claim 11, wherein the inside diameter of the through hole continuously decreases from the first inside diameter d₁ to the inside diameter dᵢ between the inlet opening with the inside diameter d₁ and the area of the flow separation edge with the inside diameter dᵢ outside of the respective indentations.

14. Tubular heat exchanger, comprising at least one heat exchanger element having a jacketed tube and at least one interior tube, and a connection element according to claim 1.

15. Method for retrofitting a flow system with a tubular heat exchanger with at least one heat exchanger element and at least one product-carrying tube, comprising:
Connecting an end of the heat exchanger element to a connection element according to claim 1 at one side of the connection element facing towards the heat exchanger element; and
Connecting the connection element to the product-carrying tube on the side facing away from the heat exchanger element.

16. The connection element according to claim 11, wherein the indentations comprise part-circular indentations.

17. The connection element according to claim 13, wherein the inside diameter dᵢ is between the respective indentations.

18. The connection element according to claim 17, wherein the indentations are part-circular indentations.
